(19) United States
(12) Patent Application Publication
(10) Pub. No.: US 2008/0297118 A1
(43) Pub. Date: Dec. 4, 2008

(54) Battery charging circuit

(76) Inventors: Hisanori Honma, Gunma (JP); Takashi Kabasawa, Gunma (JP)

Correspondence Address: WENDEROTH, LIND & PONACK, L.L.P., 2033 K STREET N. W., SUITE 800, WASHINGTON, DC, 20006-1021, US

(21) Appl. No.: 12/153,890

(22) Filed: May 27, 2008

(30) Foreign Application Priority Data
May 31, 2007 (JP) 2007-146225

(51) Int. Cl. H02J 7/04

(52) U.S. Cl. 320/145

(57) ABSTRACT

A battery charging circuit includes a power supply circuit being connected via a switching element and a current-limiting resistor to a battery to subject the battery to a trickle charge, and a control circuit turning on and off the switching element on a given duty to subject the battery to the trickle charge by means of a pulsed charge. The control circuit includes an on-timing adjustment circuit detecting a battery voltage to control the duty of turning on and off the switching element. The on-timing adjustment circuit makes a duty ratio smaller in a state of a low battery voltage than in a state of a high battery voltage and turns on and off the switching element to perform the trickle charge by means of the pulsed charge.

### BACKGROUND OF THE INVENTION

1. Field of the Invention

The present invention relates generally to a charging circuit which incorporates a pulse-charging circuit for detecting a state of a battery by subjecting the battery to a trickle charge prior to starting a charging operation of the battery.

2. Description of the Related Art

A rechargeable battery becomes degraded as it continues to be used. An abnormal battery which has been degraded cannot be recharged like a normal battery. This is because, as exemplary negative effects on charged and charging sides, such abnormal battery suffers a leakage of electrolyte or generation of heat, while the charging circuit suffers a flow of excessive current or inability to detect a full charge of the battery. Such negative effects can, however, be overcome when a normal battery alone is charged by discriminating an abnormal battery prior to a normal charging operation. The abnormal battery is detected by subjecting the battery to a trickle charge of allowing a small amount of electric current to flow. The trickle charge allows the abnormal battery to be discriminated from the normal battery in a manner that an excessive current will not flow in the abnormal battery. Judgment of the abnormal battery by means of the trickle charge is made by checking whether a battery voltage has reached a predetermined range after a certain period of time. When subjected to the trickle charge, the normal battery gains a predetermined voltage, while the abnormal battery cannot reach the predetermined range. In view of this phenomenon, the charging circuit for checking the abnormal battery is so designed as to incorporate a trickle-charging circuit in which the battery is charged with a small amount of current at an initial stage of a charging operation.

Disclosed in JP-2007-110877A is a charging circuit in which a battery is subjected to a trickle charge at an initial stage of a charging operation to prevent a negative effect which will be caused by recharging an over-discharged battery. When the over-discharged battery is recharged, the charging circuit is capable of preventing an excessive flow of electric current.

### SUMMARY OF THE INVENTION

Further, the trickle charge of a battery is performed by connecting a current-limiting resistor in series to the battery in order to limit a charging current to a small amount. FIG. 1 is a circuit diagram of a battery charger provided with a trickle-charging circuit 90. As shown in the circuit diagram, the trickle-charging circuit 90 has both of a current-limiting resistor 95 and a switching element 94 connected in series to a battery 91, with a current, which flows through the battery 91, being limited to a small amount by means of the current-limiting resistor 95. In performing the trickle charge, the current-limiting resistor 95 consumes electric power. The power consumption by the current-limiting resistor 95 is in proportion to the product of the squared value of a charging current for the trickle charge and the value of an electric resistance of the current-limiting resistor 95. The charging current flowing through the current-limiting resistor 95 is in proportion to a difference between a voltage of the battery 91 and a voltage outputted from a power supply circuit 92, and is in inverse proportion to an electric resistance. Therefore, in the trickle charge, the charging current increases as the voltage of the battery 91 becomes lower. When the charging current becomes larger, the power consumption by the current-limiting resistor 95 increases in proportion of the squared value of the charging current. The current-limiting resistor 95 heats up due to its power consumption, so that the temperature rises when a generated heat is increased by the larger power consumption. Thus, in the current-limiting resistor for subjecting a low-voltage battery to the trickle charge, the heat value becomes larger. In order to withstand the heat value, the current-limiting resistor is required to use a resistor having sufficient wattage to withstand the maximal power-consumption. To meet the need, the trickle-charging circuit capable of subjecting the low-voltage battery to a trickle charge is required to use a resistor having large wattage. A resistor with large wattage is bulky and expensive. Further, since the heat value becomes larger, the resistor has to be disposed in such a structure as may allow the heat to be dissipated. Further, a voltage range of an abnormal battery may be too wide to be specified and there may be even a battery having a very low voltage, so that, in regard to the power consumption, the current-limiting resistor is required to be a type with sufficiently large power consumption so as to be able to subject an abnormal battery having a very low voltage to the trickle charge. Therefore, the charging circuit for discriminating an abnormal battery by means of the trickle charge suffers the disadvantage of being required to be equipped with a current-limiting resistor corresponding to large power consumption, which resultantly involves a higher cost and larger size of the current-limiting resistor, in addition to having to be so structured as to sufficiently dissipate the heat, which adds to the cost.

The present invention has been made in order to overcome the above-mentioned drawbacks. It is the primary object of the present invention to provide a charging circuit in which a low-voltage battery can be subjected to a trickle charge without increased power consumption by the current-limiting resistor.

In order to achieve the above-mentioned object, the battery charging circuit of the present invention is constituted as described below. The charging circuit includes a power supply circuit 2 connected via a switching element 4 and current-limiting resistor 5 to a battery 1 to subject the battery 1 to a trickle charge, and a control circuit 3 turning on and off the switching element 4 on a given duty to subject the battery 1 to the trickle charge by means of a pulsed charge. The control circuit 3 includes an on-timing adjustment circuit 6 detecting a battery voltage to control the duty of the switching element 4. The on-timing adjustment circuit 6 makes a duty ratio smaller in a state of a low battery voltage than in a state of a high battery voltage, and turns on and off the switching element 4 to perform the trickle charge by means of the pulsed charge.

The above-described charging circuit is capable of subjecting a low voltage battery to a trickle charge without increased power consumption by a current-limiting resistor. Thus, a small-sized current-limiting resistor can be used to subject the low voltage battery to the trickle charge. Such factor can minimize the current-limiting resistor and reduce a component cost to minimum. Further, since the small-sized current-limiting resistor allows a smaller amount of electric power to be consumed and a smaller amount of heat to be generated, a structure for heat radiation can be simplified as well as enabling the small-sized resistor to be mounted on a circuit board or the like in a simplified manner, so that a total cost can be reduced to a considerable extent. Such characteristic is obtained because of the unique construction and arrangement of the inventive charging circuit, that is to say, the circuit is so uniquely structured that the trickle charge is performed by means of the pulsed charge and that the duty of the pulsed charge is altered by means of a battery voltage. In other words, in a state that a large amount of current flows from the power supply circuit due to a low voltage of the battery, the duty is altered to shorten on-time with respect to off-time, so that a variation of an average current is made smaller in subjecting the battery to the trickle charge. In particular, since the present invention is so constructed and arranged as to control the power consumption by the current-limiting resistor by altering the duty of turning on and off the switching element for performing the trickle charge by means of the pulsed charge, the circuit structure is so simplified that the power consumption by the current-limiting resistor can be securely prevented from becoming larger while charging the low voltage battery.

Another charging circuit of the present invention incorporates, in a battery pack 11, a trickle-charging circuit 10 having a control circuit 3, a switching element 4 and a current-limiting resistor 5, so as to control a pulsed charge for a battery 1 incorporated in the battery pack 11.

In the above-described charging circuit, generation of heat within the battery pack can be prevented from becoming large while subjecting the battery to the trickle charge in a state that the battery voltage is-lowered. This is because the power consumption by the current-limiting resistor incorporated in the battery pack can be controlled not to become large regardless of the battery voltage.

In yet another charging circuit of the present invention, the control circuit 3 is provided with a battery state detection circuit 7, and the battery state detection circuit 7 charges the battery 1 in trickle and pulse charging and detects the state of the battery 1.

In the above-described charging circuit, since the battery can be charged while the state of the battery is judged during the trickle charge, an overcharged battery is not charged at a large amount of current, and an abnormal battery can be prevented from being charged in the same manner of charging a normal battery.

In another charging circuit of the present invention, the control circuit 3 includes a battery state detection circuit 7, and a charging-mode switching circuit 8 controlled by the battery state detection circuit 7 to charge the battery 1 by switching into a normal charging mode and a trickle-charging mode, so that the battery state detection circuit 7 controls the charging-mode switching circuit 8 to charge, in a normal mode, the battery 1 judged to be a normal battery 1.

In the above-described charging circuit, the charging-mode switching circuit is controlled by the battery state detection circuit to charge, into a normal charging mode, the battery judged to be a normal battery. Thus, while preventing the abnormal battery from being abnormally charged, the normal battery can be charged in a normal mode.

The above and further objects of the present invention as well as the features thereof will become more apparent from the following detailed description to be made in conjunction with the accompanying drawings.

### BRIEF DESCRIPTION OF THE DRAWINGS

FIG. 1 is a circuit diagram showing a conventional type of charging circuit;

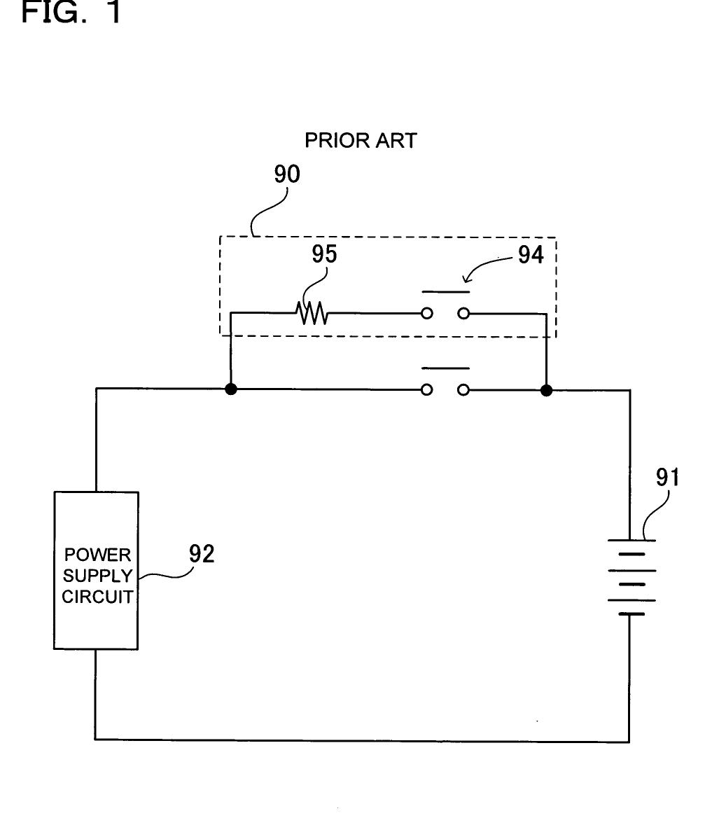

FIG. 2 is a circuit diagram showing the charging circuit in accordance with an embodiment of the present invention; and

FIG. 3 is a graph showing the state that an average current is made uniform by altering the duty of the pulsed current.

### DETAILED DESCRIPTION OF THE EMBODIMENT(S)

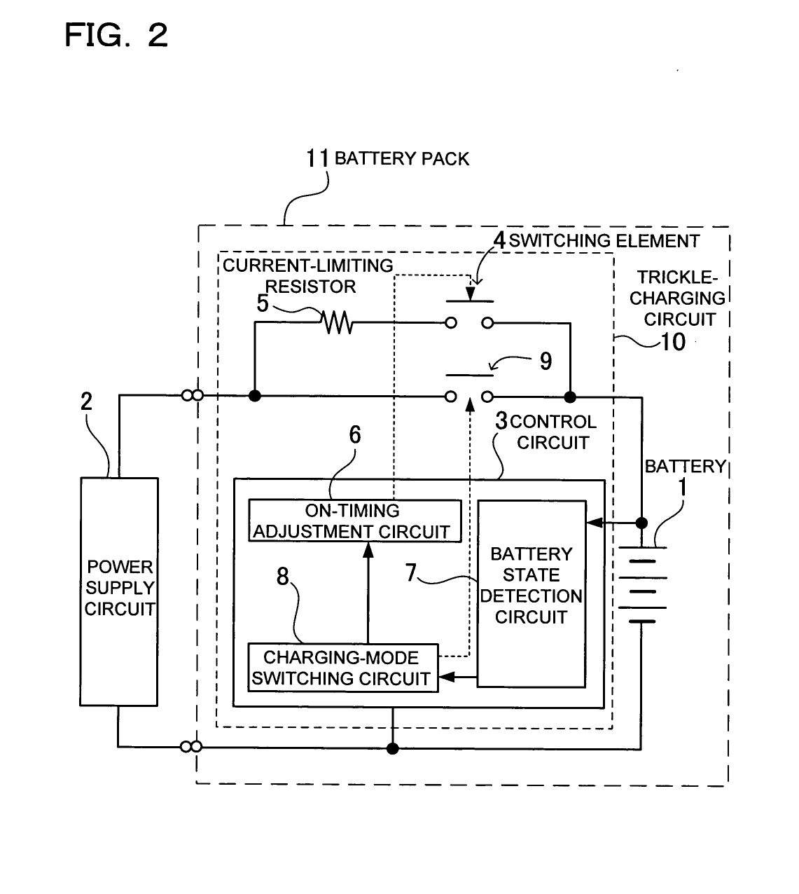

The charging circuit shown in FIG. 2 includes a power supply circuit 2 connected via a switching element 4 and a current-limiting resistor 5 to a battery 1 to subject the battery 1 to a trickle charge, and a control circuit 3 turning on and off the switching element 4 on a given duty to subject the battery 1 to the trickle charge by means of a pulsed charge. In addition, the charging circuit shown in FIG. 2 is provided with a main switch 9 for charging the battery 1 in a normal charging mode.

The switching element 4, in a state of subjecting the battery 1 to the trickle charge, is turned on and off by the control circuit 3 and subjects the battery 1 to the pulsed charge. A cycle of the switching element 4 to be turned on or off is set to be for a period of 1 sec to 10 sec, for example. The duty of turning on and off the switching element 4 serves to specify average time to be involved in subjecting the battery 1 to the trickle charge. The average current can be made smaller with a smaller duty ratio, i.e., by shorter on-time with respect to off-time, or conversely the average current can be made larger with a larger duty ratio. Even when a voltage of the battery 1 to be charged is varied, the switching element 4 is turned on and off by the control circuit 3 to obtain a duty where the average current for the trickle charge remains to be the same current.

The current-limiting resistor 5 utilizes an electric resistance to adjust a peak current for subjecting the battery 1 to the pulsed charge. This is because, in a state of the switching element 4 to be turned on, a battery charging current flows from the power supply circuit 2 through the current-limiting resistor 5 to the battery 1. The peak current flowing to the current-limiting resistor 5 in a state of the switching element 4 to be turned on is in proportion to a differential voltage between the power supply voltage and the battery voltage, and is in inverse proportion to the electric resistance by the current-limiting resistor 5. Further, the power consumption (P) by the current-limiting resistor 5 is the product of the squared value of the average current and the value of the electric resistance. Therefore, when the average current (I) for subjecting the battery 1 to the trickle charge is specified and further when the power consumption (P) by the current-limiting resistor 5 is specified, the electric resistance (R) of the current-limiting resistor 5 can be calculated in the following equation.

R=P/I²

Therefore, for example, when the average current for the trickle charge is 0.1 A and the power consumption by the current-limiting resistor 5 is 0.1 W, the electric resistance of the current-limiting resistor 5 becomes 10 Ω. In this current-limiting resistor 5 with its power consumption of 0.1 W, when a resistor with a rated power consumption of 0.5 W is used, the current-limiting resistor 5 can be used without suffering from considerable generation of heat.

The charging circuit of the present invention is not intended to allow the electric current to flow continuously through the current-limiting resistor 5. When the switching element 4 connected in series to the current-limiting resistor 5 is turned on and off, the trickle charge of the pulsed current is performed. The pulsed current, in a state that the switching element 4 is turned on, is in proportion to the differential voltage between the power supply voltage and the battery voltage and is in inverse proportion to the electric resistance. Therefore, when the differential voltage is, for example, 10 V between the power supply voltage and the battery voltage, and when the electric resistance of the current-limiting resistor 5 is 10 Ω, the peak current becomes 1 A. Further, the average current of the battery 1 subjected to the trickle charge by means of the pulsed current is the product of the peak current of the pulsed current and the duty ratio (%). Therefore, in this state, when the duty ratio of turning on and off the switching element 4 is 10%, in other words, when the switching element 4 is turned off at a timing of 90% of one cycle and is turned on at a timing of 10%, the average current is one tenth of 1 A, being equivalent to 0.1 A. That is to say, in the case of the current-limiting resistor 5 with its electric resistance of 10 Ω in a state of a difference of 10 V between the power supply voltage and the battery voltage, when the duty ratio of turning on and off is 10%, the average current can be controlled to be 0.1 A. Further, when the difference becomes 20 V between the power supply voltage and the battery voltage, the peak current of the current-limiting resistor 5 is accordingly doubled to 2 A. However, in this state, when the duty ratio is made half, being equivalent to 5%, the average current can remain unchanged, namely, being 0.1 A. Since the power consumption by the current-limiting resistor 5 is in proportion of the product of the squared value of average current and the value of electric resistance, the average current can be controlled to remain unchanged even when the peak current is large, so that the power consumption can remain unchanged, that is, the generation of heat can remain unchanged. Therefore, in the case of the current-limiting resistor 5 with its average current of 0.1 A and its electric resistance of 10 Ω, the power consumption becomes 0.1 W, so that a resistor with its rated power consumption of 0.5 W can be used to prevent the generation of heat from rising to a high temperature. It should be noted here that the current-limiting resistor 5 can be used with its rated power consumption of around 0.3 W to 2.0 W. It should also be added that the current-limiting resistor 5 can be used with its electric resistance of around several Ω to 200 Ω.

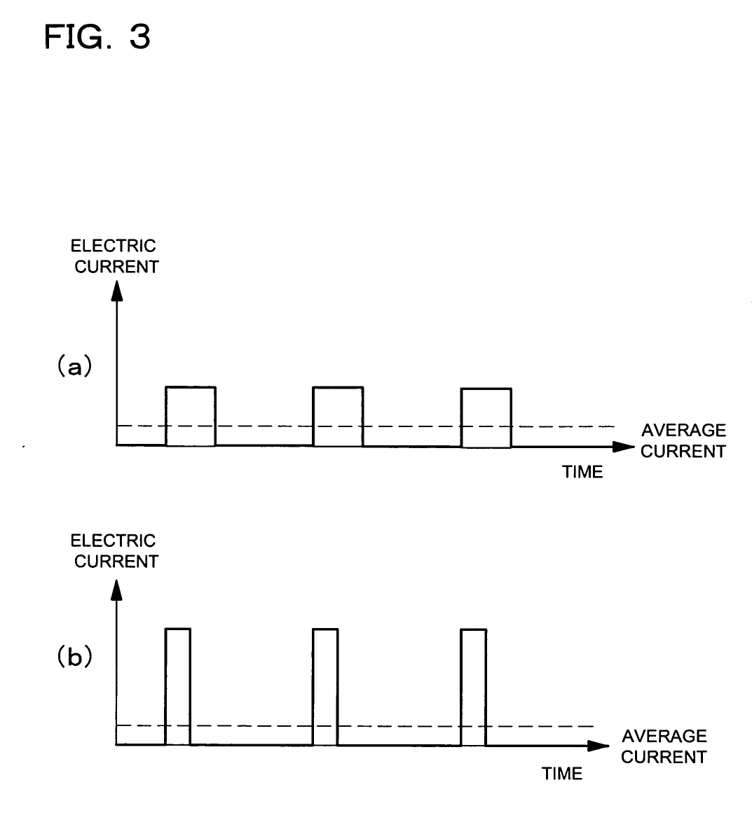

FIG. 3 shows a state that the duty of the pulsed current is altered with respect to the varying peak current to make the average current uniform. FIG. 3(a) shows a state that the battery voltage is high, that is, the differential voltage is small between the power supply voltage and the battery voltage. In this state, since the peak current flowing through the current-limiting resistor 5 becomes small, a pulse width is made large, namely, the duty ratio is made large. Further, FIG. 3(b) shows a state that the battery voltage is low, that is, the differential voltage is large between the power supply voltage and the battery voltage. In this state, since the peak current flowing through the current-limiting resistor 5 becomes large, a pulse width is made small, namely, the duty ratio is made small. As shown in the Figures, when the peak current is small, the duty ratio is made large, and when the peak current is large, the duty ratio is made small, so that the average current can resultantly be made uniform.

The control circuit 3 controls the duty of the switching element 4 in accordance with the peak current. The peak current at which the battery 1 is subjected to the pulsed charge is in proportion to the differential voltage between the power supply voltage and the battery voltage. The power supply voltage is a constant voltage because it is the voltage outputted from the power supply circuit 2. In contrast, the battery voltage is varied in accordance with a state of the battery 1 subjected to the trickle charge. Therefore, the control circuit 3 can detect the differential voltage between the power supply voltage and the battery voltage by detecting the battery voltage. However, the control circuit can also detect such differential voltage by detecting both of the power supply voltage and the battery voltage. The control circuit is thus capable of detecting the differential voltage between the power supply voltage and the battery voltage in a more accurate manner. This is because the voltage outputted from the power supply circuit is varied to some extent in accordance with the voltage of the battery, that is, the battery voltage.

Since a peak current in the pulsed charge varies with a parameter of the battery voltage, the control circuit 3 detects the battery voltage to specify the peak current, and the duty is controlled on the basis of the peak current. The illustrated control circuit 3 detecting the battery voltage is provided with an on-timing adjustment circuit 6 for controlling the duty of turning on and off the switching element 4. The on-timing adjustment circuit 6, in a state of a low battery voltage, has a large peak current, so that the switching element 4 is turned on and off with a small pulse width, that is, with a small duty ratio to subject the battery to the trickle charge by means of the pulsed charge. Further, the control circuit 3 stores in a memory circuit the duty ratio with respect to the battery voltage or alternatively the duty ratio with respect to the differential voltage between the voltage outputted from the power supply source and the battery voltage. Alternatively, the control circuit 3 has an electronic circuit implemented for uniformizing an average current in real time, regardless of the peak current in the pulsed charge. Such electronic circuit can be realized, for example, by detecting the average current and feeding it back to a duty controlling circuit. In the controlling circuit 3, the peak current in the pulsed charge varies and the average current is uniformized. However, even when the peak current in the pulsed charge varies, the control circuit 3 does not necessarily have to control the average current to be constant. This is because the charging circuit of the present invention is intended to limit the heat generated by the current-limiting resistor 5 in the pulsed charge so that the pulsed charge can be performed by the current-limiting resistor 5 with small wattage. It is not that the current-limiting resistor 5 cannot correspond at all to a variation in the power consumption but that the resistor can sufficiently correspond to some extent of variation in the power consumption. This is because, in an actual circuit, the current-limiting resistor 5 utilizes a resistor with larger wattage than the electric power consumed in the trickle charge. Therefore, the control circuit 3 controls the switching element 4 so that the duty ratio becomes smaller in a state of a large peak current than in a state of a small peak current, but the average current flowing through the current-limiting resistor 5 does not have to be controlled to be an accurately constant current. For example, when the peak current varies, the average current can also be controlled to be ±50%, preferably at ±30%, more preferably at ±20% in variation.

In the charging circuit shown in FIG. 2, the trickle-charging circuit 10 having a control circuit 3, a switching element 4 and a current-limiting resistor 5 is incorporated in a battery pack 11 having a built-in battery 1. Further, the charging circuit subjects in advance the battery 1 to the trickle charge prior to starting a charging operation for the battery 1 to detect the state of the battery 1. Therefore, the control circuit 3 is provided with a battery state detection circuit 7. The battery state detection circuit 7 subjects the battery 1 to the trickle charge (e.g., at a current value less than about 0.1 C) by means of the pulsed charge for a certain period of time (for 5 to 12 hours, e.g., 10 hours), thus detecting a voltage of the battery 1 to check the battery state. When a battery voltage reaches a given voltage (1.1 to 1.2 V per cell in the case of a nickel hydrogen battery, e.g., more than 1.15 V per cell) after the trickle charge, such battery is judged to be in a normal state, and subsequently the battery 1 is charged in a normal charging mode. In order to charge in the normal charging mode the battery 1 having been judged to be in a normal state, the charging circuit in FIG. 2 includes the battery state detection circuit 7, and the charging-mode switching circuit 8 controlled by the battery state detection circuit 7 and charging the battery 1 by switching to the normal charging mode or the trickle charge. The battery state detection circuit 7 controls the charging-mode switching circuit 8 and charges in the normal mode the battery 1 having been judged to be a normal battery 1. The charging-mode switching circuit 8, in a state of subjecting the battery 1 to the trickle charge, controls to turn on and off the switching element 4 by means of the on-timing adjustment circuit 6; and in order the charge the battery 1 in the normal charging mode, the switching element 4 is turned off and the main switch 9 is turned on. When the main switch 9 is turned on, the power supply circuit 2 fully charges the battery 1.

The above-described charging circuit first subjects the battery 1 to the trickle charge and judges whether the battery 1 is in a normal state or not. It should be noted, however, that the charging circuit of the present invention is not necessarily meant specifically for the trickle-charging operation in order to judge the state of the battery. To mention the reason, for example, the charging circuit can be used as a charging circuit to subject the battery to the trickle charge and to retain the battery in a fully charged state, or the circuit can be used as a step-up/boosting circuit for fully charging by subjecting a nearly fully charged battery to the trickle charge.

### INDUSTRIAL APPLICABILITY

Because the charging circuit of the present invention can limit, within a certain range, the power consumption by the current-limiting resistor which controls the current to be small even when the battery voltage varies while subjecting the battery to the trickle charge, the charging circuit is optimal to be used as any kind of circuit for subjecting the battery to the trickle charge, for example, as a circuit for judging whether the battery is in a normal state or not.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2007-146225 filed in Japan on May 31, 2007, the content of which is incorporated herein by reference.

What is claimed is:

1. A charging circuit comprising:
a power supply circuit having a switching element and a current-limiting resistor, the power supply circuit being connected via the switching element and the current-limiting resistor to a battery to charge the battery in trickle charge; and
a control circuit switching on/off the switching element on a given duty to charge the battery in trickle charge by means of a pulse charge,
wherein the control circuit further comprises an on-timing adjustment circuit detecting a battery voltage to control the duty of the switching element, and
wherein the on-timing adjustment circuit makes a duty ratio smaller in a state of a low battery voltage than in a state of a high battery voltage and turns on/off the switching element to perform the trickle charge by means of the pulse charge.

2. The charging circuit as recited in claim 1, further comprising:
a battery pack comprising a trickle-charging circuit having the control circuit, the switching element and the current-limiting resistor,
wherein the trickle-charging circuit is incorporated in the battery pack to control the pulse charging for the battery incorporated in the battery pack.

3. The charging circuit as recited in claim 1, wherein the control circuit sets an on/off timing of the switching element 1 sec to 10 sec.

4. The charging circuit as recited in claim 1, wherein the control circuit controls the duty of the switching element so that an average current in the trickle charging remains to be a given current in condition that a voltage of the battery to be charged is varied.

5. The charging circuit as recited in claim 1, wherein the control circuit controls the duty of the switching element so as to make the average current in the trickle charge ±50% in variation.

6. The charging circuit as recited in claim 1, wherein the control circuit detects both of the battery voltage and a power supply voltage to control the duty of the switching element.

7. The charging circuit as recited in claim 1, wherein the control circuit controls the duty of the switching element on the basis of a peak current specified by the battery voltage.

8. The charging circuit as recited in claim 1, wherein the control circuit stores in a memory circuit a duty ratio with respect to the battery voltage, and controls the duty of the switching element on the basis of the duty ratio stored in the memory.

9. The charging circuit as recited in claim 1, wherein the control circuit stores in the memory circuit the duty ratio with respect to the differential voltage between the voltage outputted from the power supply source and the battery voltage, and controls the duty of the switching circuit on the basis of the duty ratio with respect to the voltage outputted from the power supply source and the battery voltage that are stored in the memory circuit.

10. The charging circuit as recited in claim 1, wherein the control circuit is an electronic circuit for uniformizing the average current in real time, regardless of the peak current in the pulse charging.

11. The charging circuit as recited in claim 1, wherein the control circuit comprises a battery state detection circuit, and the battery state detection circuit subjects the battery to the trickle charge by means of the pulsed charge to detect a state of the battery.

12. The charging circuit as recited in claim 11, wherein the battery state detection circuit detects the battery voltage and compares the battery voltage with a given voltage to judge a normal state of the battery.

13. The charging circuit as recited in claim 11, wherein the control circuit comprises the battery state detection circuit, and a charging-mode switching circuit controlled by the battery state detection circuit to charge the battery by switching to a normal charging mode or to a trickle charge, and
wherein the battery state detection circuit controls the charging-mode switching circuit to charge the battery which is judged to be a normal battery in the normal charging mode.
